(19) United States
(12) Patent Application Publication
(10) Pub. No.: US 2026/0116304 A1
(43) Pub. Date: Apr. 30, 2026

(54) LINKAGE ASSEMBLY FOR VEHICLE STEP

(71) Applicant: Ford Global Technologies, LLC, Dearborn, MI (US)

(72) Inventors: Vishal Vinayak Nageshkar, Windsor (CA); Scott Nydam, Farmington Hills, MI (US); Sangram Laxman Tamhankar, Farmington Hills, MI (US)

(21) Appl. No.: 18/929,883

(22) Filed: Oct. 29, 2024

(51) Int. Cl. B60R 3/02; B60N 3/02

(52) U.S. Cl. CPC B60R 3/02; B60N 3/023

(57) ABSTRACT

A motor vehicle may include a body including an opening. The motor vehicle may also include a step including a deck. The motor vehicle may further include a linkage assembly configured to guide movement of the step between a stowed position and at least one deployed position. When the step is in the at least one deployed position, the step may be spaced-apart from a groundscape adjacent the motor vehicle. Further, the linkage assembly may include a first link configured such that at least a portion of the first link moves away from the opening as the step moves to the deployed position, and such that the first link is configured to provide a handhold when the step is in the at least one deployed position.

### TECHNICAL FIELD

This disclosure relates to motor vehicles having a step, and in particular relates to a linkage assembly configured to guide movement of the step.

### BACKGROUND

Some motor vehicles, such as vans, include an interior space with a passenger cabin and a cargo area. The cargo area is typically accessible via one or more doors near a rear of the vehicle. Such vans are known to include a step near the back bumper to facilitating access to the cargo area, and in particular to assist users in loading and unloading items from the cargo area. Vans with such features are sometimes referred to as “step in” vans, and are often employed for various purposes, including transportation of goods and other commercial or industrial applications.

### SUMMARY

In some aspects, the techniques described herein relate to a motor vehicle, including: a body including an opening; a step including a deck; and a linkage assembly configured to guide movement of the step between a stowed position and at least one deployed position, wherein, when the step is in the at least one deployed position, the step is spaced-apart from a groundscape adjacent the motor vehicle, and wherein the linkage assembly includes a first link configured such that at least a portion of the first link moves away from the opening as the step moves to the deployed position, and such that the first link is configured to provide a handhold when the step is in the at least one deployed position.

In some aspects, the techniques described herein relate to a motor vehicle, wherein, adjacent a first end of the first link, the first link is pivotably connected to the body at a location spaced-apart from a floor of an interior space of the motor vehicle.

In some aspects, the techniques described herein relate to a motor vehicle, wherein: adjacent a second end of the first link opposite the first end of the first link, the first link is pivotably connected to a second link adjacent a first end of the second link, and adjacent a second end of the second link opposite the first end of the second link, the second link is connected to the step.

In some aspects, the techniques described herein relate to a motor vehicle, wherein, when the step is in one of the deployed positions, the first and second links are arranged at substantially a 90° angle relative to one another.

In some aspects, the techniques described herein relate to a motor vehicle, wherein, when the step is one of the deployed positions, the first link is substantially parallel to the groundscape and the second link is substantially perpendicular to the groundscape.

In some aspects, the techniques described herein relate to a motor vehicle, wherein the second link is configured to provide a handhold when the step is in the at least one deployed position.

In some aspects, the techniques described herein relate to a motor vehicle, wherein, when the step is in the stowed position, at least one of the first and second links is at least partially received in a recess formed in the body.

In some aspects, the techniques described herein relate to a motor vehicle, wherein, adjacent a second end of the first link opposite the first end of the first link, the first link is connected to the step.

In some aspects, the techniques described herein relate to a motor vehicle, wherein, adjacent the first end of the first link, the first link is coupled to the body such that the first link is configured to both pivot and slide relative to the body.

In some aspects, the techniques described herein relate to a motor vehicle, wherein the body incudes a slot, and a pin coupled to the first link adjacent the first end of the first link projects into the slot.

In some aspects, the techniques described herein relate to a motor vehicle, wherein the first link includes markings configured to provide a visual cue as to the presence of the handhold.

In some aspects, the techniques described herein relate to a motor vehicle, wherein the handhold is provided by a cover configured to fit over a portion of the first link.

In some aspects, the techniques described herein relate to a motor vehicle, further including a door configured to open and close to selectively uncover and cover the opening, and wherein, when the step is in the stowed position and the door is closed, the first link is at least partially received in a recess formed in the door.

In some aspects, the techniques described herein relate to a motor vehicle, wherein the first link is generally arranged on an opposite side of the step as the groundscape.

In some aspects, the techniques described herein relate to a motor vehicle, further including: a floor of an interior space of the motor vehicle; a motor configured to move the linkage assembly to adjust a position of the step; at least one sensor configured to obtain information indicative of a height of the deck relative to the groundscape; and a controller configured to interpret the information from the at least one sensor to determine the height of the deck relative to the groundscape and the floor, and wherein the controller is configured to instruct the motor to adjust the position of the deck to the at least one deployed position.

In some aspects, the techniques described herein relate to a motor vehicle, wherein the at least one deployed position is substantially halfway between the groundscape and the floor.

In some aspects, the techniques described herein relate to a motor vehicle, wherein the groundscape is a groundscape directly beneath the step, or beneath the step and rearward of the step.

In some aspects, the techniques described herein relate to a motor vehicle, further including another linkage assembly configured to guide movement of the step between the stowed position and the at least one deployed position.

In some aspects, the techniques described herein relate to a motor vehicle, wherein: the linkage assembly includes another link, adjacent a first end of the other link, the other link is connected to the body, and adjacent a second end of the other link opposite the first end of the other link, the other link is connected to the step.

In some aspects, the techniques described herein relate to a method, including: guiding movement of a step between a stowed position and at least one deployed position in which the step is spaced-apart from a groundscape adjacent a motor vehicle by a linkage assembly, wherein the linkage assembly includes a first link configured such that at least a portion of the first link moves away from an opening in a body of the motor vehicle as the step moves to the deployed position, and such that the first link is configured to provide a handhold when the step is in the at least one deployed position.

### BRIEF DESCRIPTION OF THE DRAWINGS

FIG. 1 is a rear perspective view of an example motor vehicle.

FIG. 2 is a rear perspective view of a portion of the example motor vehicle including a first linkage assembly and with a step in a stowed position.

FIG. 3 is a rear perspective view of a portion of the example motor vehicle including the first linkage assembly and with the step in a deployed position.

FIG. 4 is a close up view of the first linkage assembly, with the step in a deployed position.

FIG. 5 is a close up view of a second linkage assembly, with the step in a stowed position.

FIG. 6 is a close up view of the second linkage assembly, with the step in a deployed position.

FIG. 7 is a view of a door configured with an exemplary recess to accommodate the linkage assembly.

### DETAILED DESCRIPTION

This disclosure relates to motor vehicles having a step, and in particular relates to a linkage assembly configured to guide movement of the step. Among other benefits, this disclosure sets a position of a step at a convenient height for a user, while also providing one or more convenient handholds for the user. These and other benefits will be appreciated from the following description.

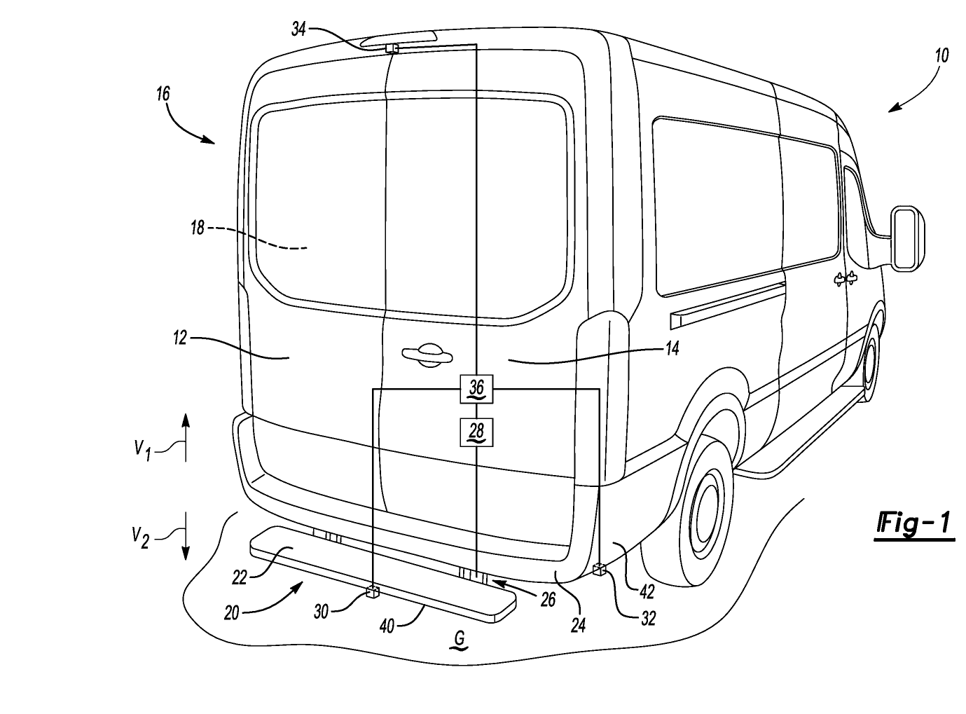

Referring to the drawings, FIG. 1 is a rear-perspective view of a motor vehicle 10 (“vehicle 10”). The vehicle 10 in this example is a van. The vehicle 10 includes two doors 12, 14 adjacent a rear 16 of the vehicle 10 configured to open and close to selectively permit access to, and enclose, respectively, an interior space 18, which in this example includes a cargo area, from the rear. While a van is pictured, this disclosure is also applicable to other types of vehicles, such as trucks, buses, etc.

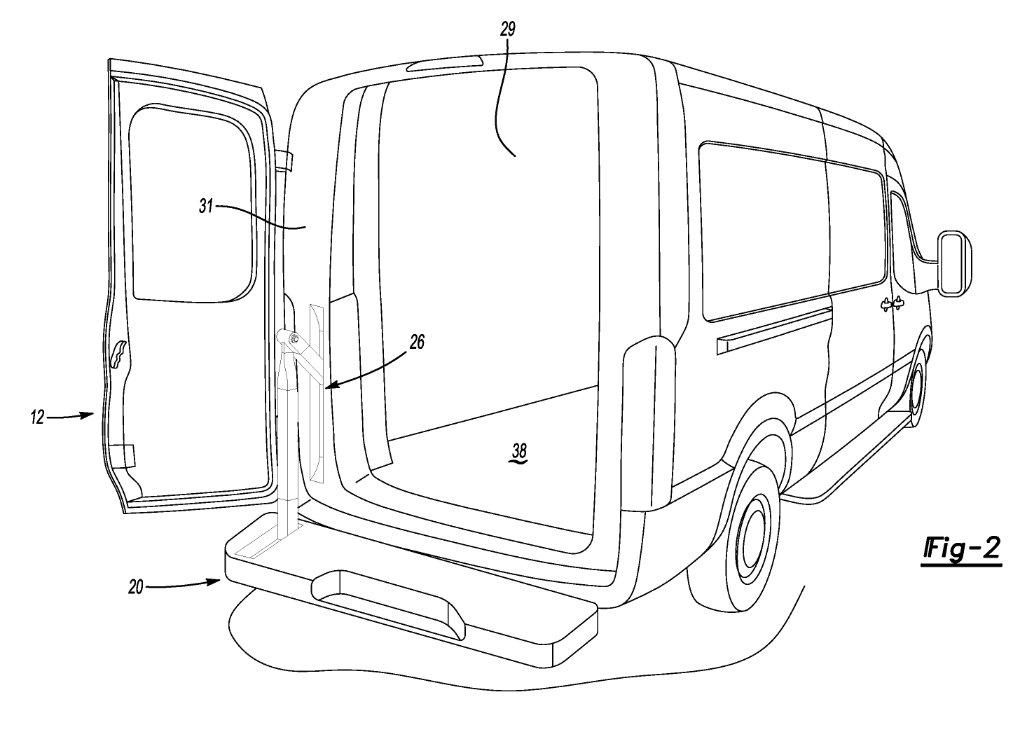

The vehicle 10 includes a step 20. The step 20 includes a deck 22, which provides an upper surface upon which a user can place their feet when stepping into or out of the interior space 18. The deck 22 may include ridges, ribs, or other friction features to increase traction relative to a foot, or footwear, of a user. As will be discussed in more detail below, the step 20 is configured to move between a stowed position and at least one deployed position. In this example, the step 20 generally moves vertically in a vertically upward direction V1 and in a vertically downward direction V₂ relative to a groundscape G adjacent the vehicle 10. The step 20 is also able to move toward and away from an opening 29 (FIG. 2) in the body 31 (FIG. 2) of the vehicle 10. The openings 29 is selectively covered and uncovered by doors 12, 14. While the opening 29 is in the rear of the body 31, this disclosure extends to openings, and steps, arranged at other locations of a vehicle, such as a side of a vehicle.

Groundscape G, in this disclosure, refers to both naturally occurring ground surfaces, such as rock, grass, dirt, etc., as well as constructed elements that are generally on or near the naturally occurring ground surface, including concrete, curbs, steps, loading docks, etc.

In the embodiment of FIG. 1, the step 20 is independent of a rear bumper 24 of the vehicle 10. In particular, the step 20 is spaced-apart from the rear bumper 24 such that vertical movement of the step 20 will not interfere with the rear bumper 24. In other examples, the step 20 is integrated into, and provides, a rear bumper of the vehicle 10. In those examples, the rear bumper is moveable vertically together with movement of the step 20.

The vehicle 10 includes a linkage assembly 26 configured to guide movement of the step 20, and a motor 28 configured to move the linkage assembly 26 to adjust a position of the step 20. The vehicle 10 further includes at least one sensor. Each of the at least one sensors may be an assembly including a plurality of sensors. In FIG. 1, the vehicle 10 is shown with three sensors 30, 32, 34. A controller 36 is configured to interpret signals and information from the at least one sensor to determine the height of the deck 22 relative to the groundscape G and to determine the height of the step 20 and the deck 22 relative to a floor 38 (FIG. 2) of the interior space 18. The floor 38 is the bottom surface of the interior space 18, and in particular is the floor surface the user first touches when stepping into the interior space 18, or last touches when leaving the interior space 18.

In this disclosure, the controller 36 is configured to instruct the motor 28 to adjust the position of the deck 22 to be substantially halfway between the groundscape G and the floor 38. Doing so provides even step heights for a user between the groundscape G and the floor 38. This disclosure is not limited to a deployed position in which the position of the deck 22 is at the halfway point between the groundscape G and the floor 38, and instead encompasses other deployed positions for the deck 22, including all deployed positions in which the deck 22 is spaced-apart from the groundscape G, and in particular in which the step 20 and deck 22 are spaced-apart vertically above the groundscape G.

The controller 36 is shown schematically in FIG. 1. It should be understood that the controller 36 could be part of an overall vehicle control module, such as a vehicle system controller (VSC), or could alternatively be a stand-alone controller separate from the VSC. Further, the controller 36 may be programmed with executable instructions for interfacing with and operating the various components of the vehicle 10. The controller 36 may be operable in response to signals from a key fob, a vehicle infotainment system, or a mobile device of a user, for example. The controller 36 additionally includes a processing unit and non-transitory memory for executing the various control strategies and modes of the vehicle system.

In one example, the motor 28 is an electric motor, and is responsive to instructions from the controller 36 to selectively adjust a position of the linkage assembly 26, and in turn the step 20 and the deck 22. While one motor 28 is shown, additional motors could be provided.

With respect to the sensors 30, 32, 34, each sensor is shown in an exemplary location. In particular, in the embodiment of FIG. 1, the sensor 30 is mounted to an underside 40 of the step 20. The sensor 32 is mounted to an underbody of the vehicle 10. Further, the sensor 34 is mounted adjacent a top of the vehicle 10 and adjacent an access point to the interior space 18, namely adjacent a rear opening in the vehicle 10. The sensor 34 could be incorporated into a center high-mounted stop lamp (CHMSL) or a rear back-up camera of the vehicle 10. While three sensors 30, 32, 34 are shown, this disclosure extends to vehicles having a different number of sensors.

In a particular aspect of this disclosure, sensors 30, 32 are ranging sensors. Specifically, sensors 30, 32 are either a light detection and ranging (LIDAR) sensors or radio detecting and imaging (RADAR) sensors. The sensor 34, in this example, is a depth perception sensor. Specifically, the sensor 34 is a sensor assembly including at least a color camera and a time of flight sensor. The sensor 34 may include a color camera, a time of flight sensor, and a near-infrared (NIR) sensor in a single assembly, in one embodiment. When the sensor includes a time of flight sensor, a color hue scale may be used, and each color is associated with a unique code, which may be alphanumeric, and can be interpreted by the controller 36 as corresponding to a height.

Each of the sensors 30, 32, 34 could be provided by one or more color cameras, RADAR sensors, LIDAR sensors, ultrasonic sensors, or near-infrared (NIR) sensors, as examples. It should be understood that this disclosure extends to vehicles that have different sensor systems. For example, as discussed below, in one embodiment the vehicle 10 includes sensors 30 and 32, but not sensor 34. In another embodiment, the vehicle 10 includes sensor 34 but not sensors 30 or 32.

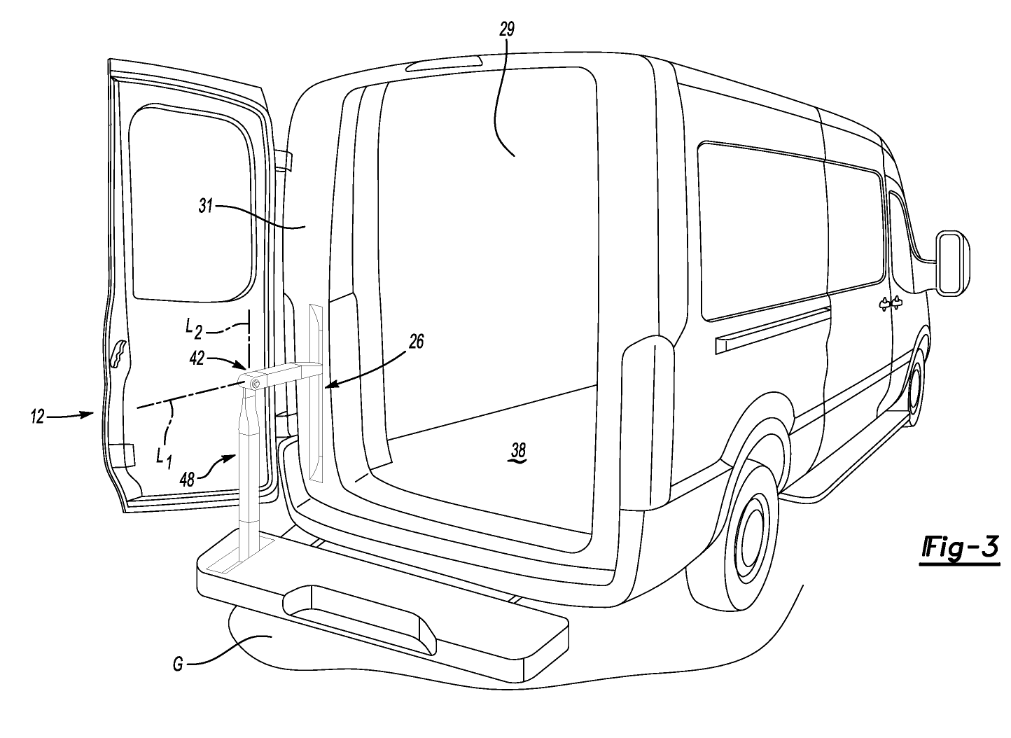

FIGS. 2 and 3 illustrate the step 20 in a stowed position and a deployed position, respectively. In FIGS. 2 and 3, only one door 12 is shown, and door 12 is in an open position. The door 14 has been removed for ease of reference.

FIGS. 2 and 3 illustrate a first configuration of the linkage assembly 26. The linkage assembly 26 is configured such that at least a portion of a link moves away from the opening 29 as the step 20 moves to the deployed position, and such that that link is configured to provide a handhold when the step 20 is in the at least one deployed position.

It should be understood that the vehicle 10 may include another, substantially identical, arrangement of the linkage assembly 26 on an opposite side of the step 20, for example. In that another example, there may be only one powered linkage assembly configured to actively move the step 20. Specifically, the vehicle 10 may include a linkage assembly 26 and motor 28 adjacent one side of the step 20, and adjacent the other side of the step 20 there may be a non-powered linkage assembly including linkage arrangement similar to linkage assembly 26, for example, and configured to guide the movement of the step 20 without being directly powered by a motor.

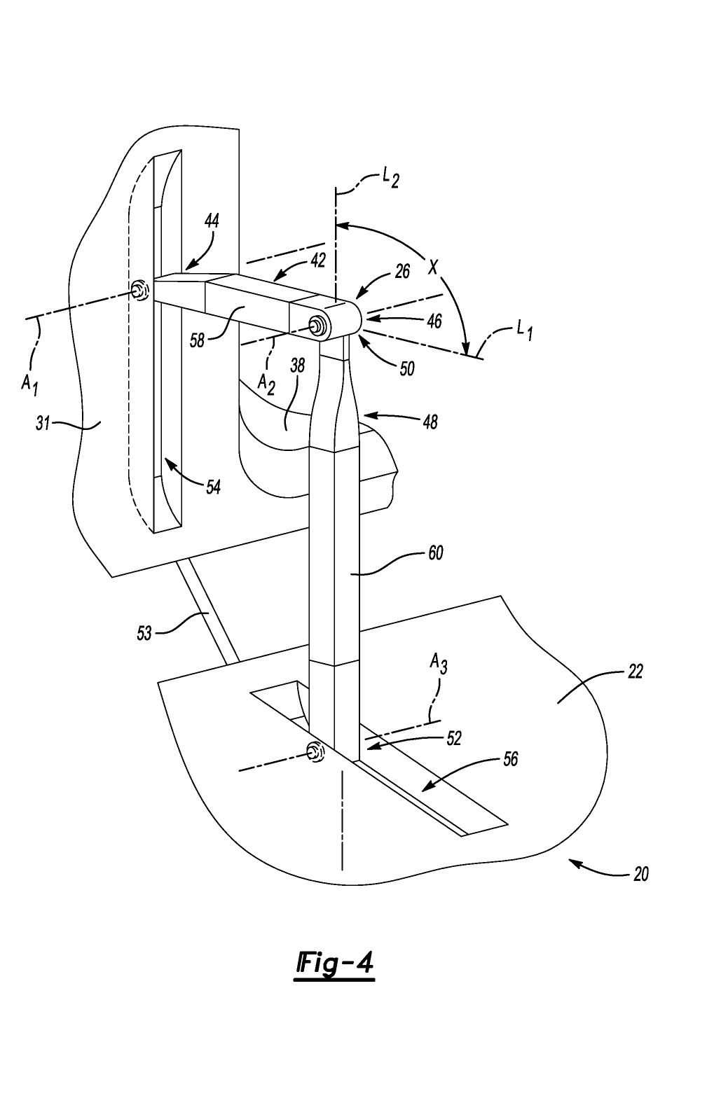

The linkage assembly 26 is shown in detail in FIG. 4. In FIG. 4, portions of the body 31 and step 20 are shown transparent for ease of reference. The linkage assembly 26 includes a first link 42 including a first end 44 and a second end 46 opposite the first end 44. Adjacent the first end 44, the first link 42 is pivotably attached to the to the body 31. The first link 42 is pivotable about axis A1 relative to the body 31, and, in this example, is not slidable, such as being vertically moveable, relative to the body 31. The axis A1 is at a location spaced-apart vertically above floor 38. Adjacent the second end 46, the first link 42 is pivotably connected to a second link 48. The second link 48 includes a first end 50 and a second end 52 opposite the first end 50. The first and second links 42, 48 are pivotable relative to one another about axis A2 adjacent the second end 46 and the first end 50. The second link 48 is pivotably connected to the step 20 adjacent the second end 52. Specifically, the second link 48 is pivotably connected to the step about axis A3. The first and second links 42, 48 are arranged generally on an opposite side of the step 20 as the groundscape G.

The linkage assembly further includes a third link 53. The third link 53 can facilitate movement of the step 20 between the stowed and deployed positions. Together, the step 20, the first link 42, the second link 48, and third link 53 substantially establish a four-bar linkage.

The third link 53 may be a follower link, which is not actively driven by a motor, for example. In another example, the third link 53 may be a driven link, which is driven by motor 28, and which is able to cause movement of the step 20, the first link 42, and second link 48. More particularly, the third link 53 may be provided by a screw-type mechanism such as a spindle, a ball screw, or a slider. Further, the third link 53 may be hydraulic or pneumatic. The motor 28 and third link 53 are also configured to cooperate hold the linkage assembly 26 in place to as to limit movement of the linkage assembly 26 when the step 20 is in a desired position.

While the third link 53 is described as being the driven link, another link, such as the first link 42, could be the driven link, with the second link 48 and third link 53 being follower links. In that example, the motor 28 may operably connected to the pivot joint adjacent the first end 44 of the first link 42. In another example, the motor 28 could be integrated into the step 20 and configured to drive the second link 48 via connection to the pivot joint adjacent the second end 52 of the second link 48, with the first and third links 42, 53 being followers.

The first, second, and third links 42, 48, 53 are configured such that, when the step 20 moves from the stowed position to a deployed position, the deck 22 essentially translates vertically (i.e., downwardly in direction V2) and away (i.e., rearwardly) from the opening 29. The deck 22 remains facing substantially vertically upward when moving between the stowed and deployed positions. In other embodiments, the first, second, and third links 42, 48, 53 could be configured such that the deck 22 rotates when moving between the stowed and deployed positions.

The various pivoting connections in this disclosure are formed by structures known to establish pivoting joints, such as by providing pins, or pin-like structures, into recesses. This disclosure is not limited to any particular type of pivot joint. The pivot joints may also be provided by, for example, threaded members, threaded fasteners, and/or washers.

A first recess 54, which in this example is a trough, is formed in the body 31 adjacent the first end 44. A second recess 56, which in this example is also a trough, is formed in the deck 22. The recesses 54, 56 may facilitate movement of the first and second links 42, 48 as the step 20 is moved between the stowed and deployed positions. In particular, when the step 20 is in the stowed position, at least a portion of the first link 42 may project into the first recess 54, and at least a portion of the second link 48 may project into the second recess 56. The first recess 54 projects vertically above axis A1 and below axis A1, in this example. The second recess 56 projects outward of axis A3 and inward of axis A3, in this example. The recesses 54, 56 facilitate a more compact arrangement of the linkage assembly 26 when the step 20 is in the stowed position. The recesses 54, 56 further facilitate assembly and maintenance.

The first and second links 42, 48 are arranged relative to one another so as to provide a convenient handhold for a user entering or exiting the interior space 18 using the step 20. A length dimension of the first link 42 extends generally along a first longitudinal axis L1, and a length dimension of the second link 48 extends generally along a second longitudinal axis L2. When the step is in the deployed position, as in FIGS. 3 and 4, the first longitudinal axis L1 and the second longitudinal axis L2 are arranged at an angle X, which is substantially 90°. Further, the first longitudinal axis L1 is arranged substantially parallel to the groundscape G, and the second longitudinal axis L2 is arranged substantially perpendicular to the groundscape G.

A portion of the first link 42 provides a first handhold 58 and a portion of the second link 48 provides a second handhold 60. The first and second handholds 58, 60 may be made of a material, such as rubber, different from a remainder of the first and second links 42, 48, which may be made of metal or hard plastic. The first and second handholds 58, 60 may exhibit a different surface texture than a remainder of the first and second links 42, 48. While the drawings illustrate an embodiment with both of the first and second handholds 58, 60, this disclosure extends to embodiments with a different number of handholds, including one handhold or no handholds. The first and second handholds 58, 60, when present, could include markings configured to provide a visual cue as to the presence of the corresponding handhold. The first and second handholds 58, 60 could be provided by covers configured to fit relative to the first and second links 42, 48. Example markings include stripes and/or bright coloring, for example. The markings may be provided by reflective striping, in an example.

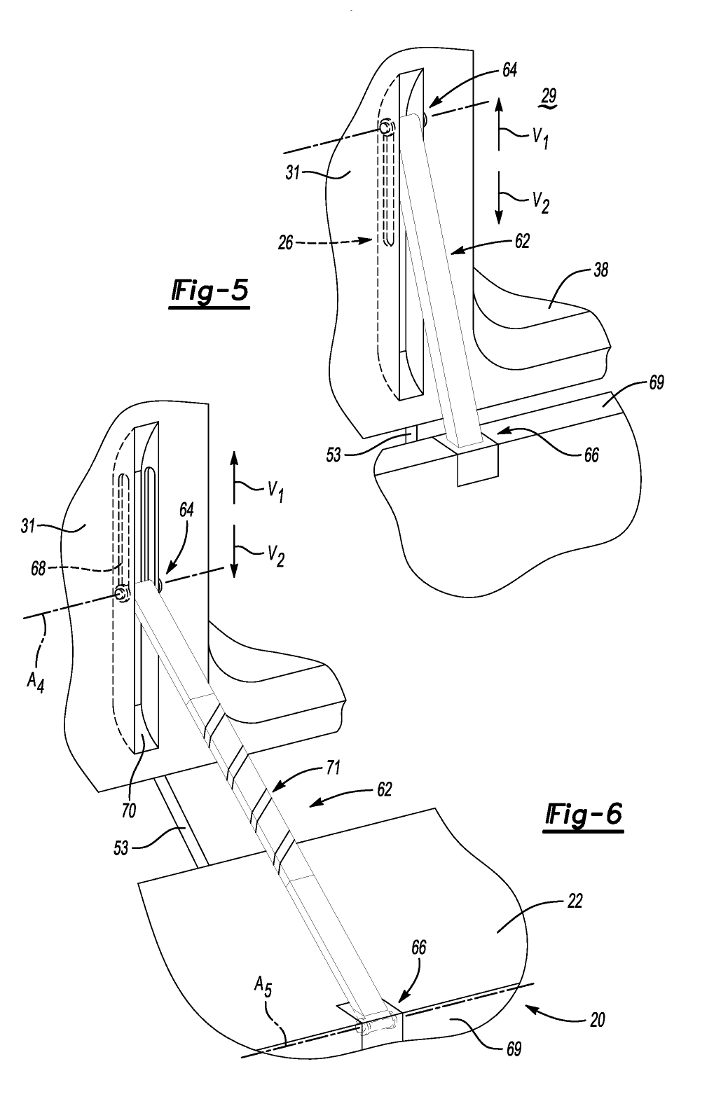

FIGS. 5 and 6 illustrate another example configuration of the linkage assembly 26, with the step 20 in a stowed position and a deployed position, respectively. In FIGS. 5 and 6, portions of the body 31 are shown transparent. With reference to FIGS. 5 and 6, the linkage assembly 26 includes a first link 62 including a first end 64 and a second end 66 opposite the first end 64. As with the embodiment of FIGS. 2-4, a portion of the first link 62 moves away from the opening 29 as the step 20 moves to the deployed position, and the first link 62 is configured to provide a handhold when the step 20 is in the deployed position.

Adjacent the first end 64, the first link 62 is pivotably attached to the to the body 31. The first link 62 is pivotable about axis A4 relative to the body 31. In this example, the first link 62 is configured to both rotate and slide relative to the body 31. In particular, the first link 62 is configured to rotate relative to the body 31 about axis A4, and the first link 62 is configured to slide vertically in directions V1 or V2 relative to the body 31 because the first end 64, which includes or is connected to a pin or pin-like structure, is able to travel vertically within an elongate slot 68 formed in a recess 70 in the body 31. The sliding and rotating connection between the first link 62 and the body 31 may include pins, wheels, etc.

Adjacent the second end 66, the first link 62 is pivotably connected to the step 20. Specifically, adjacent the second end 66, the first link 62 is pivotably connected to the step 20 about axis A5. The connection between the first link 62 and the step 20 may be embedded into the step 20 or attached as a pin-jointed eye-loop adjacent the deck 22, as examples. The first link 62 is arranged generally on an opposite side of the step 20 as the groundscape G.

The body 31 acts as a second link, in this example. The linkage assembly 26 further includes a third link 53. The third link 53 can facilitate movement of the step 20 between the stowed and deployed positions. Together, the step 20, the first link 62, the body 31, and third link 53 substantially establish a four-bar linkage.

The third link 53 may be a follower link, which is not actively driven by a motor, for example. In another example, the third link 53 may be a driven link, which is driven by motor 28, and which is able to guide movement of the step 20 and the first link 62.

In the embodiment of FIGS. 5 and 6, the linkage assembly 26 is configured such that the deck 22 rotates when moving between the stowed and deployed positions. In particular, an outer edge 69 of the step 20 is configured to rotate away from the opening 29 when moving from the stowed position to the deployed position. The step 20 may also move vertically as the outer edge 69 rotates. The third link 53 may be coupled to the step 20 and the body 31 to facilitate such movement. In other embodiments, the first link 62, body 31, and third link 53 could be configured such that the step 20 translates without rotating when moving between the stowed and deployed positions.

The recess 70 may facilitate movement of the first link 62 as the step is moved between the stowed and deployed positions. In particular, when the step 20 is in the stowed position, at least a portion of the first link 62 may project into the first recess 70. The recess 70 projects vertically above axis A4 and below axis A4, in this example. As with the above-discussed recesses, the recess 70 facilitates a more compact arrangement of the linkage assembly 26 when the step 20 is in the stowed position. The recess 70 further facilitates assembly and maintenance.

A portion of the first link 62 is configured to provide a convenient handhold 71 for a user entering or exiting the interior space 18 using the step 20. As with the above-discussed handholds, the handhold 71 may be made of a material, such as rubber, different from a remainder of the first link 62, which may be made of metal or hard plastic. The handhold 71 may exhibit a different surface texture than a remainder of the first link 61. The handhold 71, when present, could include markings configured to provide a visual cue as to the presence of the corresponding handhold. The handhold 71 could be provided by covers configured to fit relative to the first link 62. Example markings include reflective stripes, as shown in FIG. 6, and/or bright coloring, for example.

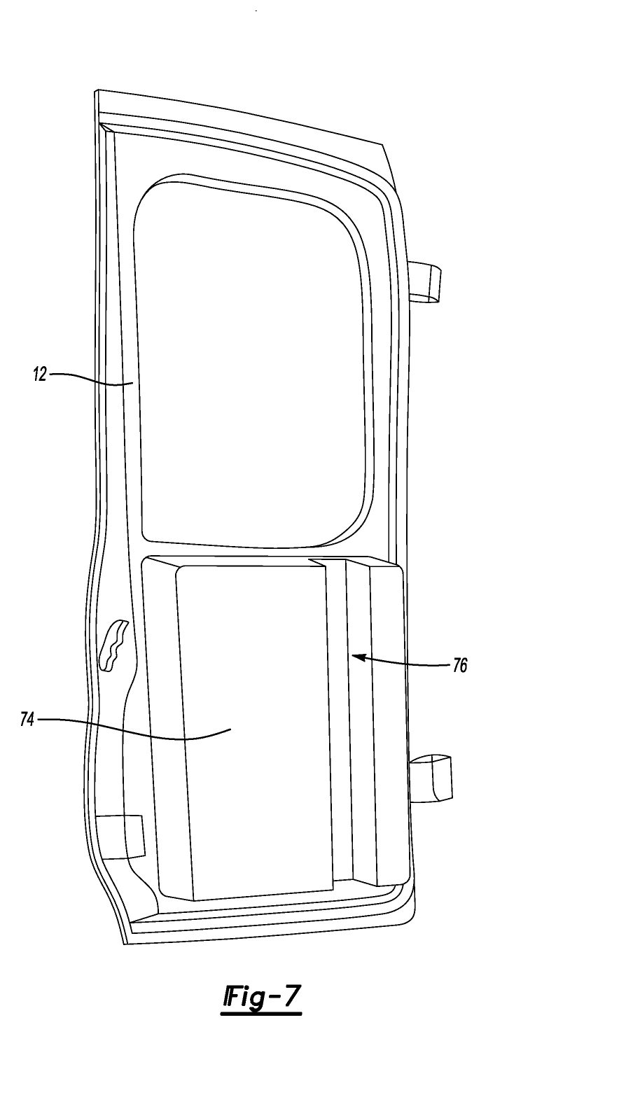

FIG. 7 illustrates an example configuration of the door 12. As shown, an inner panel 74 of the door 12 includes a recess 76 configured to at least partially receive at least one link of the linkage assembly 26. When the inner panel 74 is provided by one or more trim pieces, the trim may be molded to provide the recess 76. When the inner panel 74 lacks trim, the door 12 may be formed to provide the recess 76, including by bending or by incorporating the recess into a die used for imprinting the door 12. The recess 76 could include a cutout and an insert within the cutout. In that case, removing the insert could provide access to the internals of the door 12, for maintenance. The configuration of FIG. 7 can be used with either of the above-discussed embodiments, and may be configured to receive at least a portion of the first link 42 and second link 48 when the step 20 is in the stowed position, or to receive a portion of the first link 62 when the step 20 is in the stowed position.

An example technique for adjusting the position of the step 20 will now be described. During use of the vehicle 10 in which the vehicle 10 is moving, the step 20 is held in a stowed position. The stowed position is adjacent the rear bumper, in an example, and is a highest vertical position of the step 20.

When the vehicle 10 is stationary and in park, in an example, the controller 36 is configured to interpret signals from the sensors 30, 32, 34 to determine a height of the floor 38 relative to the groundscape G. If the height exceeds a predefined threshold height, the controller 36 instructs the motor 28 to move the linkage assembly 26 to lower the step 20 from the stowed position to a deployed position in which the step 20 and deck 22 are both at a height above the groundscape G. In an example, the deck 22 is at a height substantially half the height between the floor 38 and the groundscape G. Substantially half, in this disclosure, means half, within an industry-accepted tolerance. The heights are measured in a direction perpendicular to the groundscape G. In this example, the sensors 30, 32, 34 are configured to sense the relative position of the step 20 and underbody 42, respectively, relative to the groundscape G directly underneath, or alternatively underneath and rearward of, the respective sensors 30, 32, 34.

In an aspect of this disclosure, the controller 36 is programmed with the vertical dimensions, or thicknesses, of various components and can factor those thicknesses into its interpretation of the signals from the various sensors.

In an aspect of this disclosure, the vehicle 10 is configured to move the step 20 to the deployed position automatically, requiring minimal or no user intervention. In one specific aspect of this disclosure, the controller 36 may be programmed to automatically move the step from a stowed position to a deployed position every time the vehicle 10 is stationary, in park, and when the doors 12, 14 opened. Alternatively, the controller 36 may be in communication with automatic door openers, and may programmed to automatically open the doors 12, 14 and move the step 20 from a stowed position to a deployed position every time the vehicle 10 is stationary and in park. These aspects of the disclosure may be useful when the vehicle 10 is used for deliveries, such as when a user is making frequent stops and is frequently needing to enter and exit the interior space 18. In another aspect, the controller 36 may deploy the step 20 in response to another type of signal. The signal may be initiated by a user request, such as by a user pressing a button in the interior space 18 of the vehicle 10. Despite the user pressing a button, the user involvement is minimal, and the process of deploying the step 20 is still considered automatic in this disclosure. The controller 36 could alternatively be configured to deploy the step 20 when a user is detected in the interior space 18 or near a rear of the vehicle 10.

It should be understood that terms such as “about,” “substantially,” and “generally” are not intended to be boundaryless terms, and should be interpreted consistent with the way one skilled in the art would interpret those terms. Further, directional terms such as “forward,” “rearward,” “upward,” “downward,” “vertical,” “horizontal,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a body including an opening;
a step including a deck; and
a linkage assembly configured to guide movement of the step between a stowed position and at least one deployed position, wherein, when the step is in the at least one deployed position, the step is spaced-apart from a groundscape adjacent the motor vehicle, and wherein the linkage assembly includes a first link configured such that at least a portion of the first link moves away from the opening as the step moves to the deployed position, and such that the first link is configured to provide a handhold when the step is in the at least one deployed position.

2. The motor vehicle as recited in claim 1, wherein, adjacent a first end of the first link, the first link is pivotably connected to the body at a location spaced-apart from a floor of an interior space of the motor vehicle.

3. The motor vehicle as recited in claim 2, wherein:
adjacent a second end of the first link opposite the first end of the first link, the first link is pivotably connected to a second link adjacent a first end of the second link, and
adjacent a second end of the second link opposite the first end of the second link, the second link is connected to the step.

4. The motor vehicle as recited in claim 3, wherein, when the step is in one of the deployed positions, the first and second links are arranged at substantially a 90° angle relative to one another.

5. The motor vehicle as recited in claim 3, wherein, when the step is one of the deployed positions, the first link is substantially parallel to the groundscape and the second link is substantially perpendicular to the groundscape.

6. The motor vehicle as recited in claim 3, wherein the second link is configured to provide a handhold when the step is in the at least one deployed position.

7. The motor vehicle as recited in claim 3, wherein, when the step is in the stowed position, at least one of the first and second links is at least partially received in a recess formed in the body.

8. The motor vehicle as recited in claim 2, wherein, adjacent a second end of the first link opposite the first end of the first link, the first link is connected to the step.

9. The motor vehicle as recited in claim 8, wherein, adjacent the first end of the first link, the first link is coupled to the body such that the first link is configured to both pivot and slide relative to the body.

10. The motor vehicle as recited in claim 9, wherein the body incudes a slot, and a pin coupled to the first link adjacent the first end of the first link projects into the slot.

11. The motor vehicle as recited in claim 1, wherein the first link includes markings configured to provide a visual cue as to the presence of the handhold.

12. The motor vehicle as recited in claim 11, wherein the handhold is provided by a cover configured to fit over a portion of the first link.

13. The motor vehicle as recited in claim 1, further comprising a door configured to open and close to selectively uncover and cover the opening, and wherein, when the step is in the stowed position and the door is closed, the first link is at least partially received in a recess formed in the door.

14. The motor vehicle as recited in claim 1, wherein the first link is generally arranged on an opposite side of the step as the groundscape.

15. The motor vehicle as recited in claim 1, further comprising:
a floor of an interior space of the motor vehicle;
a motor configured to move the linkage assembly to adjust a position of the step;
at least one sensor configured to obtain information indicative of a height of the deck relative to the groundscape; and
a controller configured to interpret the information from the at least one sensor to determine the height of the deck relative to the groundscape and the floor, and wherein the controller is configured to instruct the motor to adjust the position of the deck to the at least one deployed position.

16. The motor vehicle as recited in claim 15, wherein the at least one deployed position is substantially halfway between the groundscape and the floor.

17. The motor vehicle as recited in claim 1, wherein the groundscape is a groundscape directly beneath the step, or beneath the step and rearward of the step.

18. The motor vehicle as recited in claim 1, further comprising another linkage assembly configured to guide movement of the step between the stowed position and the at least one deployed position.

19. The motor vehicle as recited in claim 1, wherein:
the linkage assembly includes another link,
adjacent a first end of the other link, the other link is connected to the body, and
adjacent a second end of the other link opposite the first end of the other link, the other link is connected to the step.

20. A method, comprising:
guiding movement of a step between a stowed position and at least one deployed position in which the step is spaced-apart from a groundscape adjacent a motor vehicle by a linkage assembly, wherein the linkage assembly includes a first link configured such that at least a portion of the first link moves away from an opening in a body of the motor vehicle as the step moves to the deployed position, and such that the first link is configured to provide a handhold when the step is in the at least one deployed position.
